(19) United States
(12) Patent Application Publication
(10) Pub. No.: US 2023/0402222 A1
(43) Pub. Date: Dec. 14, 2023

(54) COIL DEVICE

(71) Applicant: TDK CORPORATION, Tokyo (JP)

(72) Inventor: Kyosuke INUI, Tokyo (JP)

(73) Assignee: TDK CORPORATION, Tokyo (JP)

(21) Appl. No.: 18/328,521

(22) Filed: Jun. 2, 2023

(30) Foreign Application Priority Data
Jun. 13, 2022 (JP) 2022-095150

(51) Int. Cl. H01F 27/29; H01F 27/28

(52) U.S. Cl. CPC H01F 27/292; H01F 27/2828

(57) ABSTRACT

A coil device includes a core, a coil, and an electrode. The coil includes a winding portion disposed inside the core and a lead portion leading from the winding portion. The electrode is formed on an electrode formation surface of the core. The lead portion includes a terminal portion extending to the electrode formation surface. The terminal portion includes an embedded portion embedded inside the core and an exposed portion exposed from the electrode formation surface and connected to the electrode. The exposed portion includes a bent portion.

### BACKGROUND OF THE INVENTION

The present application relates to a coil device.

Various techniques are proposed for coil devices used as inductors and the like. For example, the coil device of Patent Document 1 includes a core, a coil embedded inside the core, and an electrode formed on the surface of the core. A lead portion of the coil includes an exposed portion exposed from the surface of the core, and the electrode is formed on the surface of the core so as to cover the exposed portion. In the coil device of Patent Document 1, since the electrode covers the exposed portion, it is possible to ensure an electrical connection between the electrode and the lead portion.

As wires become thinner and coil devices become smaller, however, the contact area between the exposed portion and the electrode decreases. Thus, the contact resistance between the exposed portion and the electrode increases, and the electrical reliability of the coil device may decrease. In addition, the bonding strength between the exposed portion and the electrode decreases, and the fixing strength between the electrode and the mounting board may decrease.
Patent Document 1: JP2013149814 (A)

### BRIEF SUMMARY OF THE INVENTION

The present application has been achieved under such circumstances. It is an object of the application to provide a coil device having a high electrical reliability and an excellent fixing strength between an electrode and a mounting board.

To achieve the above object, a coil device according to the present application comprises:
a core;
a coil including a winding portion disposed inside the core and a lead portion leading from the winding portion; and
an electrode formed on an electrode formation surface of the core,
wherein
the lead portion includes a terminal portion extending to the electrode formation surface,
the terminal portion includes:
   an embedded portion embedded inside the core; and
   an exposed portion exposed from the electrode formation surface and connected to the electrode, and
the exposed portion includes a bent portion.

In the coil device according to the present application, the exposed portion includes a bent portion. Thus, the exposed portion extends along the electrode formation surface while being bent at the bent portion. Thus, it is possible to extend the length of the exposed portion in its extension direction (the length of the exposed portion from one end to the other end in its extension direction) and to increase the surface area (exposed area) of the exposed portion. In this case, since the contact area between the exposed portion and the electrode is increased, it is possible to reduce the contact resistance between the exposed portion and the electrode and to achieve a coil device having an excellent electrical reliability. Moreover, it is possible to increase the bonding strength between the exposed portion and the electrode and to improve the fixing strength between the electrode and the mounting board.

The exposed portion may include a first extension portion and a second extension portion extending along the electrode formation surface and continuing via the bent portion. In this case, the length of the exposed portion in its extension direction can be adjusted according to the length of each of the first extension portion and the second extension portion in its extension direction.

The first extension portion and the second extension portion may be arranged substantially in parallel. In this case, since the first extension portion and the second extension portion are arranged in parallel, it is possible to improve the bonding strength between the exposed portion and the electrode along the extension directions of the first extension portion and the second extension portion.

The first extension portion and the second extension portion may be continuous at a predetermined angle. In this case, it is possible to extend the length of the exposed portion in its extension direction according to the angle formed between the first extension portion and the second extension portion.

The electrode may include a first electrode and a second electrode, the first electrode and the second electrode may be arranged separately along a first direction, and the first extension portion and the second extension portion may extend along a second direction. In this case, a contact region between the exposed portion and the electrode is formed along the second direction. Thus, it is possible to form a region with a high bonding strength between the exposed portion and the electrode (i.e., a region with a high fixing strength between the electrode and the mounting board) along the second direction.

A first end and a second end of the exposed portion in its extension direction may be arranged on one side in the second direction, and the bent portion may be disposed on the other side in the second direction. In this case, it is easy to secure the length from the first end of the exposed portion in its extension direction to the bent portion and the length from the second end of the exposed portion in its extension direction to the bent portion, and it is possible to increase the length of the exposed portion in its extension direction.

The first end of the exposed portion in its extension direction may be disposed on one side of the electrode formation surface in the second direction relative to the second end of the exposed portion in its extension direction. In this case, the length from the first end of the exposed portion in its extension direction to the bent portion (i.e., the length of either one of the first extension portion and the second extension portion in its extension direction) is larger than the length from the second end of the exposed portion in its extension direction to the bent portion (i.e., the length of the other one of the first extension portion and the second extension portion in its extension direction). Thus, it is possible to adjust the length of the exposed portion in its extension direction.

The electrode may include a first electrode and a second electrode, the first electrode and the second electrode may be arranged at a predetermined interval along the electrode formation surface in a first direction, and the first extension portion and the second extension portion may extend along the electrode formation surface in the first direction. In this case, a contact region between the exposed portion and the electrode is formed along the first direction. Thus, it is possible to form a region with a high bonding strength between the exposed portion and the electrode (i.e., a region with a high fixing strength between the electrode and the mounting board) along the first direction.

The lead portion may include a connection portion connecting the winding portion and the terminal portion, the first extension portion may be connected to the connection portion, and the second extension portion may be disposed closer to a center of the core than the first extension portion. In this case, compared to when the second extension portion is disposed on the outer side of the core relative to the first extension portion, it is easy to secure an installation space for the second extension portion, and it is possible to extend the length of the exposed portion in its extension direction.

The bent portion may have a substantially U shape. In this case, the exposed portion is bent so as to make a U-turn at the bent portion. Thus, it is easy to secure the length of the exposed portion in its extension direction, and it is possible to extend the length of the exposed portion in its extension direction.

The bent portion may comprise a plurality of bent portions. In this case, the length of the exposed portion in its extension direction can be extended according to the number of bent portions.

The lead portion may include a first lead portion and a second lead portion, the terminal portion may include: a first terminal portion provided on the first lead portion; and a second terminal portion provided on the second lead portion, the exposed portion may include: a first exposed portion provided on the first terminal portion; and a second exposed portion provided on the second terminal portion, and the first exposed portion and the second exposed portion may have substantially the same shape. In this case, the electrical resistance of the first exposed portion and the electrical resistance of the second exposed portion are approximately the same, and the electrical reliability of the coil device can be improved.

The electrode may be made of a conductive paste. In this case, when the coil device is mounted on a mounting board by, for example, solder, the function of the conductive paste as a buffer layer can prevent the generation of solder cracks.

The electrode may have a maximum thickness in a region between the first extension portion and the second extension portion. In this case, in the region between the first extension portion and the second extension portion, the contact area between the electrode and the mounting board is increased, and the fixing strength between the electrode and the mounting board can be improved.

The coil may comprise a wire covered with an insulating film, and a surface of the embedded portion may be covered with the insulating film. In this case, the embedded portion and the core are insulated from each other via the insulating film, and it is possible to prevent the occurrence of a short circuit failure between the embedded portion and the core.

The coil may comprise a wire covered with an insulating film, and an end of the exposed portion in its width direction orthogonal to its extension direction may be covered with the insulating film. In this case, the exposed portion and the core (the magnetic substance contained in the core) are insulated via the insulating film, and it is possible to prevent a short-circuit failure between the exposed portion and the core.

The coil may comprise a wire covered with an insulating film, an end of the exposed portion in its width direction orthogonal to its extension direction may be covered with the insulating film, and the insulating film may have a larger thickness on the side where the first extension portion and the second extension portion are opposed to each other than on the side where the first extension portion and the second extension portion are not opposed to each other. In this case, it is possible to improve the withstand voltage between the first extension portion and the second extension portion via the thick insulating film on the side where the first extension portion and the second extension portion are opposed to each other. Thus, the electrical reliability of the coil device can be improved.

### BRIEF DESCRIPTION OF THE DRAWING(S)

FIG. 1 is a perspective view of a coil device according to First Embodiment of the present application;

FIG. 2 is a plan view of the coil device shown in FIG. 1 as viewed from the mounting surface side;

FIG. 3 is a perspective view of a coil shown in FIG. 1;

FIG. 4 is a cross-sectional view in the vicinity of a terminal portion of a lead portion shown in FIG. 1;

FIG. 5 is a plan view of exposed portions of lead portions shown in FIG. 1 as viewed from the mounting surface side;

FIG. 6A is a figure illustrating a step of manufacturing the coil device shown in FIG. 1;

FIG. 6B is a figure illustrating the next step of the step shown in FIG. 6A;

FIG. 6C is a figure illustrating the next step of the step shown in FIG. 6B;

FIG. 6D is a figure illustrating the next step of the step shown in FIG. 6C;

FIG. 6E is a figure illustrating the next step of the step shown in FIG. 6D;

FIG. 7 is a cross-sectional view illustrating an installation mode of terminal portions on a bottom surface of a first molded body shown in FIG. 6B;

FIG. 8A is a plan view of a coil device according to Second Embodiment of the present application as viewed from the mounting surface side;

FIG. 8B is a plan view of a coil device according to Third Embodiment of the present application as viewed from the mounting surface side;

FIG. 8C is a plan view of a coil device according to Fourth Embodiment of the present application as viewed from the mounting surface side;

FIG. 8D is a plan view of a coil device according to Fifth Embodiment of the present application as viewed from the mounting surface side;

FIG. 9 is a perspective view of a coil device according to Sixth Embodiment of the present application; and

FIG. 10 is a perspective view of a modification of the coil device shown in FIG. 1.

### DETAILED DESCRIPTION OF THE INVENTION

Embodiments of the present application are described with reference to the drawings. Although the embodiments of the present application are described with reference to the drawings as necessary, the illustrated contents are only schematically and exemplarily shown for understanding of the present application, and the appearance, dimensional ratio, etc. may be different from the actual one. Hereinafter, the present application is specifically described based on the embodiments, but is not limited to these embodiments.

### First Embodiment

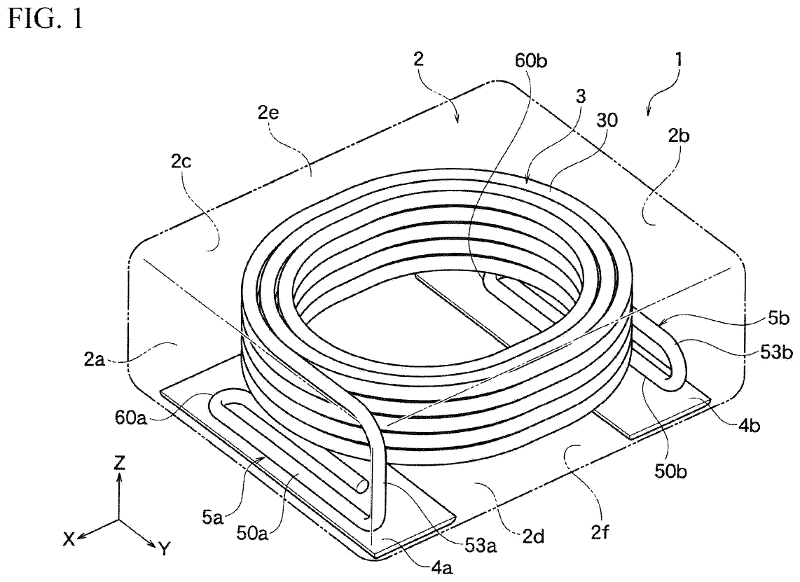

As shown in FIG. 1, a coil device 1 according to First Embodiment of the present application is, for example, a surface-mounted inductor and is mounted on various electronic devices. The dimensions of the coil device 1 are not limited. For example, the coil device 1 has a width of 1.0 to 7.0 mm in the X-axis direction, a width of 1.0 to 7.0 mm in the Y-axis direction, and a width of 0.5 to 5.0 mm in the Z-axis direction.

The coil device 1 includes a core 2, a coil 3, and electrodes 4a and 4b. The core 2 has a substantially rectangular parallelepiped shape and includes a first surface 2a, a second surface 2b, a third surface 2c, a fourth surface 2d, a fifth surface 2e, and a sixth surface 2f. The first surface 2a and the second surface 2b are opposed to each other in a first direction, the third surface 2c and the fourth surface 2d are opposed to each other in a second direction, and the fifth surface 2e and the sixth surface 2f are opposed to each other in a third direction. The first direction, the second direction, and the third direction are orthogonal to each other. In the figures, the X-axis is the axis corresponding to the first direction, the Y-axis is the axis corresponding to the second direction, and the Z-axis is the axis corresponding to the third direction. The origin of the XYZ coordinate system is determined at the center of the core 2. Regarding each of the X-axis, Y-axis, and Z-axis, the positive side of the origin is referred to as “one side”, and the negative side of the origin is referred to as “the other side”.

The electrodes 4a and 4b are arranged on the sixth surface 2f of the core 2. In this case, the sixth surface 2f is an electrode formation surface of the core 2. The electrode formation surface may be the first surface 2a, the second surface 2b, the third surface 2c, the fourth surface 2d, or the fifth surface 2e. Moreover, the electrode formation surface may consist of one surface or may consist of two or more surfaces.

The core 2 is composed of a material containing a magnetic substance and a resin. Examples of the magnetic material constituting the core 2 include ferrite particles and metal magnetic particles. Examples of the ferrite particles include Ni—Zn based ferrite and Mn—Zn based ferrite. The metal magnetic particles are not limited and are, for example, Fe—Ni alloy powder, Fe—Si alloy powder, Fe—Si—Cr alloy powder, Fe—Co alloy powder, Fe—Si—Al alloy powder, amorphous iron, or the like. The resin constituting the core 2 is not limited and is, for example, epoxy resin, phenol resin, polyester resin, polyurethane resin, polyimide resin, other synthetic resins, non-magnetic materials, or the like. The core 2 may be a sintered body of metal magnetic substance.

The core 2 is formed by powder compaction, injection molding, or the like. The shape of the core 2 is not limited to a substantially rectangular parallelepiped shape and may be another polygonal shape or a substantially cylindrical shape. Moreover, the core 2 may consist of one molded body or may be formed by combining (compressing) a plurality of molded bodies (a plurality of layers).

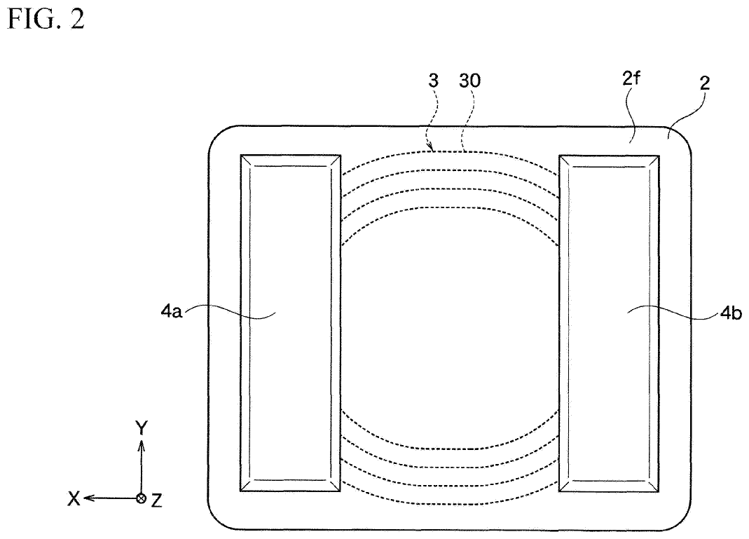

As shown in FIG. 2, the electrodes 4a and 4b are arranged separately in the X-axis direction on the sixth surface 2f of the core 2. The electrodes 4a and 4b have a substantially rectangular shape whose longitudinal direction is the Y-axis direction when viewed from the Z-axis direction. The positions, sizes, and ranges of the electrodes 4a and 4b are not limited to those of the example shown in FIG. 2 and may be changed as appropriate. The thickness of the electrodes 4a and 4b is not limited and is, for example, 10 to 200 μm. The electrodes 4a and 4b are composed of a conductive paste.

The conductive paste may contain conductive particles and an organic binder. The conductive paste contains at least one selected from Au, Ag, Cu, Ni, C, Pd, Ag—Pd alloy, etc. as a metal constituting the conductive particles. As the organic binder, it is possible to use, for example, epoxy based resin, phenol based resin, acrylic based resin, urethane based resin, silicone based resin, polyimide based resin, or the like.

When the electrodes 4a and 4b are formed with the conductive paste, the bonding strength between the electrodes 4a and 4b and the core 2 can be improved, and the terminal strength can be improved. The composition of the electrodes 4a and 4b is not limited to the conductive paste. Moreover, the electrodes 4a and 4b may include a plated layer or a base electrode layer.

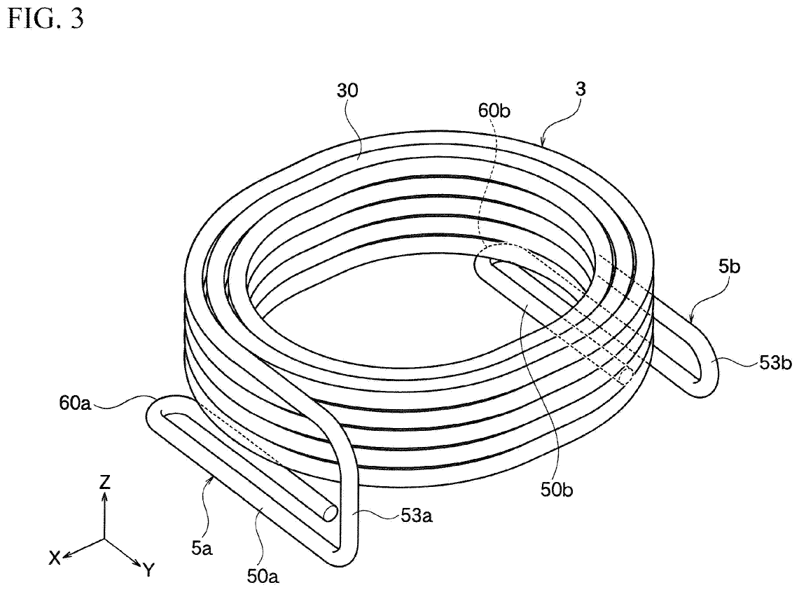

As shown in FIG. 3, the coil 3 is an air-core coil and is formed of an insulated round wire. The material of the wire is copper, silver, alloys containing them, or other metals or alloys. For example, the wire has a diameter of 10 to 80 μm.

The coil 3 includes a winding portion 30 and lead portions 5a and 5b leading from the winding portion 30. The winding portion 30 is a portion where the wire is wound in a coil shape, the lead portion 5a is a portion from the winding portion 30 to one end of the wire, and the lead portion 5b is a portion from the winding portion 30 to the other end of the wire. The winding axis direction of the winding portion 30 corresponds to the Z-axis direction and is a direction orthogonal to the fifth surface 2e and the sixth surface 2f of the core 2 (FIG. 1). The number of turns of the winding portion 30 is not limited and is one turn or more. The winding portion 30 has a substantially elliptical shape when viewed from the Z-axis direction, but may have a circular shape or another shape. As shown in FIG. 1, the winding portion 30 is embedded inside the core 2.

The lead portion 5a constitutes one end portion of the coil 3 and includes a terminal portion 50a and a connection portion 53a. The lead portion 5b constitutes the other end portion of the coil 3 and includes a terminal portion 50b and a connection portion 53b. The lead portion 5a is led out, for example, from the uppermost turn of the winding portion 30 in the Z-axis direction toward the sixth surface 2f of the core 2. The lead portion 5b is led out, for example, from the lowermost turn of the winding portion 30 in its winding axis direction toward the sixth surface 2f of the core 2.

The terminal portions 50a and 50b are arranged on the sixth surface 2f of the core 2 so as to have a substantially U shape. The terminal portions 50a and 50b are arranged separately in the X-axis direction.

The connection portion 53a connects the winding portion 30 and the terminal portion 50a. The connection portion 53b is embedded inside the core 2 and connects the winding portion 30 and the terminal portion 50b. The connection portions 53a and 53b extend while being bent from the position of the winding portion 30 to the positions of the terminal portions 50a and 50b.

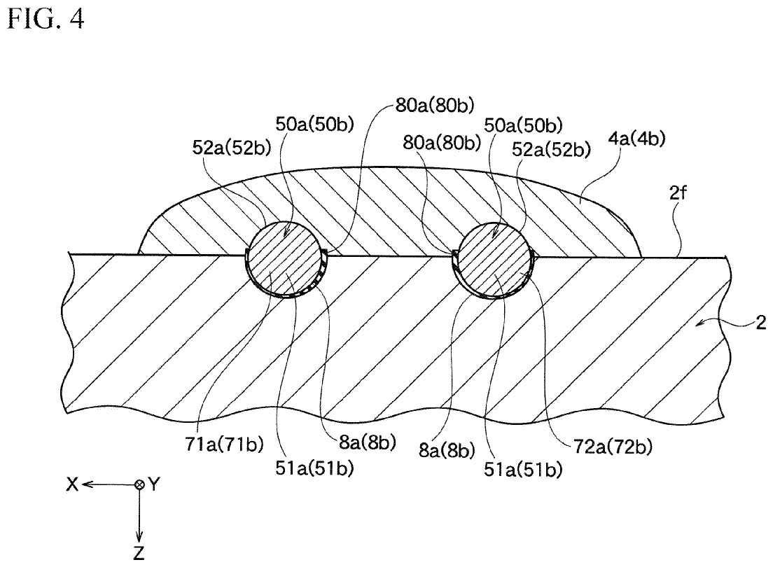

As shown in FIG. 4, the terminal portion 50a includes an embedded portion 51a and an exposed portion 52a, and the terminal portion 50b includes an embedded portion 51b and an exposed portion 52b. The embedded portions 51a and 51b are embedded inside the core 2. Thus, it is possible to prevent the terminal portions 50a and from peeling off from the sixth surface 2f of the core 2.

The surfaces of the embedded portions 51a and 51b are covered with insulating films 8a and 8b, respectively. As described above, the coil 3 is made of an insulated wire, and the embedded portions 51a and 51b include the insulating films 8a and 8b. Thus, the embedded portions 51a and 51b and the core 2 are insulated from each other via the insulating films 8a and 8b, and it is possible to prevent the occurrence of a short circuit failure between them.

The exposed portions 52a and 52b are exposed (projected) from the sixth surface 2f of the core 2. The exposed portions 52a and 52b are covered with the electrodes 4a and 4b, respectively, and are physically and electrically connected to the electrodes 4a and 4b. A part of the exposed portions 52a and 52b may also include the insulating films 8a and 8b as long as the electrical connection with the electrodes 4a and 4b is not disturbed. In the example shown in FIG. 4, the ratio of the embedded portions 51a and 51b is larger than that of the exposed portions 52a and 52b in the terminal portions 50a and 50b. In this case, it is possible to prevent the terminal portions 50a and from peeling off from the core 2. However, the ratio of the exposed portions 52a and 52b may be larger than that of the embedded portions 51a and 51b. In this case, the connection strength between the exposed portions 52a and 52b and the electrodes 4a and 4b can be improved.

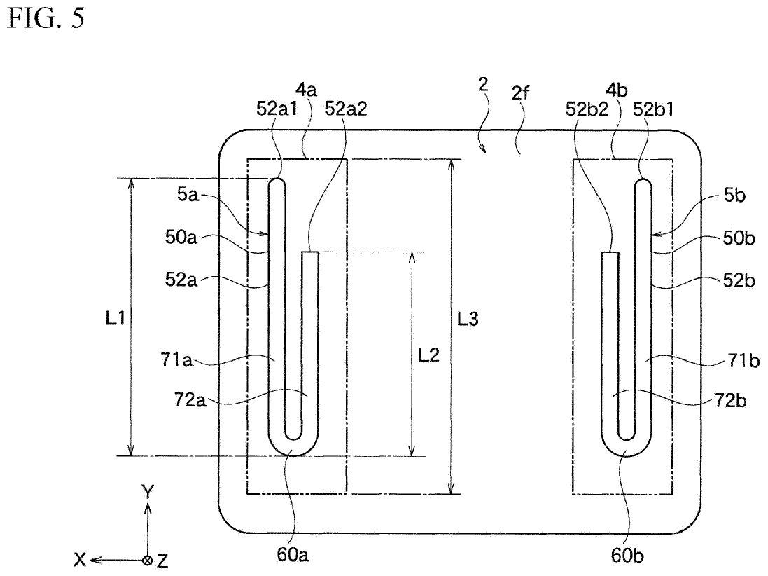

As shown in FIG. 5, the exposed portions 52a and 52b have substantially the same shape and are symmetrical with respect to the center line of the core 2 parallel to the Y-axis. However, the exposed portions 52a and 52b may be formed point-symmetrically with respect to the center of the core 2. In the following description, only the exposed portion 52a may be described for the common structure between the exposed portions 52a and 52b in order to avoid duplicate description.

Both of the exposed portions 52a and 52b have a substantially U shape when viewed from the Z-axis direction. When the exposed portions 52a and 52b have substantially the same shape, the electrical resistance of the exposed portion 52a and the electrical resistance of the exposed portion 52b are approximately the same, and the electrical reliability of the coil device 1 can be improved. In the present embodiment, the term “the same” means not only exactly the same, but also means that variation within ±5% of the entire length in the Y-axis direction or the entire width in the X-axis direction of the exposed portion 52a or 52b is allowed.

The exposed portions 52a and 52b include bent portions 60a and 60b, respectively. The bent portions 60a and 60b have a substantially U shape and are bent (smoothly curved) along the sixth surface 2f of the core 2 by approximately 180°. The bent portions 60a and 60b serve to change the extension directions of the exposed portions 52a and 52b, respectively. Thus, the exposed portions 52a and 52b are bent by approximately 180° so as to make a U-turn at the bent portions 60a and 60b, respectively.

The bent portion 60a is a portion of the exposed portion 52a excluding a first extension portion 71a and a second extension portion 72a described below. The bent portion 60a is also a portion that does not extend along the Y-axis direction and is bent (turned) between the first extension portion 71a and the second extension portion 72a. The bent portion 60b is a portion of the exposed portion 52b excluding a first extension portion 71b and a second extension portion 72b described below. The bent portion 60b is also a portion that does not extend along the Y-axis direction and is bent (turned) between the first extension portion 71b and the second extension portion 72b.

The exposed portion 52a includes a first extension portion 71a and a second extension portion 72a. The first extension portion 71a and the second extension portion 72a are arranged separately in the X-axis direction. The first extension portion 71a and the second extension portion 72a extend along the sixth surface 2f of the core 2 and are continuous via the bent portion 60a. The first extension portion 71a and the second extension portion 72a extend along the Y-axis direction on the sixth surface 2f. However, the first extension portion 71a and the second extension portion 72a may be inclined with respect to the Y-axis. In the present embodiment, “parallel” means that variation within ±5% is allowed.

The exposed portion 52b includes a first extension portion 71b and a second extension portion 72b. The first extension portion 71b and the second extension portion 72b are arranged separately in the X-axis direction. The first extension portion 71b and the second extension portion 72b extend along the sixth surface 2f of the core 2 and are continuous via the bent portion 60b. The first extension portion 71b and the second extension portion 72b extend along the Y-axis direction on the sixth surface 2f. However, the first extension portion 71b and/or the second extension portion 72b may be inclined with respect to the Y-axis.

The exposed portion 52a includes a first end 52a1, which is one end in its extension direction, and a second end 52a2, which is the other end in its extension direction. The first end 52a1 is an end located on the other side of the bent portion 60a in the Y-axis direction and is connected to the connection portion 53a (FIG. 1). The second end 52a2 is an end located on the other side of the bent portion 60a in the Y-axis direction and is also an end of the lead portion 5a. The first end 52a1 is located on the positive side of the sixth surface 2f in the Y-axis direction, and the bent portion 60a is located on the negative side of the sixth surface 2f in the Y-axis direction.

The exposed portion 52b includes a first end 52b1, which is one end in its extension direction, and a second end 52b2, which is the other end in its extension direction. The first end 52b1 is an end located on the other side of the bent portion 60b in the Y-axis direction and is connected to the connection portion 53b (FIG. 1). The second end 52b2 is an end located on the other side of the bent portion 60b in the Y-axis direction and is also an end of the lead portion 5b. The first end 52b1 is located on the positive side of the sixth surface 2f in the Y-axis direction, and the bent portion 60b is located on the negative side of the sixth surface 2f in the Y-axis direction.

The exposed portions 52a and 52b extend along the sixth surface 2f while being bent at the bent portions 60a and 60b, respectively. Thus, it is possible to increase the lengths of the exposed portions 52a and 52b in their extension directions (the length of the substantially U-shaped portion of the exposed portion 52a from the first end 52a1 to the second end 52a2 and the length of the substantially U-shaped portion of the exposed portion 52b from the first end 52b1 to the second end 52b2). This makes it possible to increase the surface areas (exposed areas) of the exposed portions 52a and 52b and increase the contact areas between the exposed portions 52a and 52b and the electrodes 4a and 4b.

The first end 52a1 and the second end 52a2 are arranged on the positive side of the sixth surface 2f of the core 2 in the Y-axis direction. On the other hand, the bent portion 60a is disposed on the negative side of the sixth surface 2f of the core 2 in the Y-axis direction. The same applies to the positional relation among the first end 52b1, the second end 52b2, and the bent portion 60b.

Thus, it is easy to secure the length from the bent portion 60a to the first end 52a1 in the Y-axis direction (a length L1 of the first extension portion 71a in the Y-axis direction) and the length from the bent portion 60a to the second end 52a2 (a length L2 of the extension portion 72a in the Y-axis direction), and it is possible to increase the length of the exposed portion 52a in its extension direction.

The first end 52a1 of the exposed portion 52a is disposed on the positive side of the sixth surface 2f of the core 2 in the Y-axis direction relative to the second end 52a2. The same applies to the first end 52b1 and the second end 52b2 of the exposed portion 52b. Thus, the length L1 of the first extension portion 71a in the Y-axis direction is larger than the length L2 of the second extension portion 72a in the Y-axis direction. 1<L1/L2≤2 may be satisfied, where L1/L2 is a ratio of the length L1 of the first extension portion 71a in the Y-axis direction to the length L2 of the second extension portion 72a in the Y-axis direction.

The length L1 of the first extension portion 71a in the Y-axis direction may be ½ or more of a length L3 of the electrode 4a in the Y-axis direction. Likewise, the length L2 of the second extension portion 72a in the Y-axis direction may be ½ or more of the length L3 of the electrode 4a in the Y-axis direction. In this case, it becomes easier to secure a contact area between the exposed portion 52a and the electrode 4a.

The second extension portion 72a is disposed closer to the center of the core 2 than the first extension portion 71a. Moreover, the second extension portion 72b is disposed closer to the center of the core 2 than the first extension portion 71b. Compared to the outer side (outer edge) of the core 2, a comparatively large space is formed on the center side of the core 2. Thus, it is possible to secure an installation space for the second extension portions 72a and 72b and to increase the lengths of the exposed portions 52a and 52b in their extension directions.

As shown in FIG. 4, the thickness of the electrode 4a (the same applies to the electrode 4b) increases toward the center of the electrode 4a in the X-axis direction. In particular, the thickness of the electrode 4a becomes maximum in the region between the first extension portion 71a and the second extension portion 72a. That is, the electrode 4a has a convex shape whose top is positioned between the first extension portion 71a and the second extension portion 72a.

Thus, in the region between the first extension portion 71a and the second extension portion 72a, the contact area between the electrode 4a and the mounting board is increased, and the fixing strength between the electrode 4a and the mounting board can be improved.

The end of the exposed portion 52a in the X-axis direction is covered with the insulating film 8a. Likewise, the end of the exposed portion 52b in the X-axis direction is covered with the insulating film 8b. Thus, the exposed portion 52a and the core 2 (the magnetic substance contained in the core 2) are insulated via the insulating film 8a, and it is possible to prevent a short-circuit failure between the exposed portion 52a and the core 2.

In particular, the insulating film 8a has a larger thickness on the side where the first extension portion 71a and the second extension portion 72a are opposed to each other than on the side where the first extension portion 71a and the second extension portion 72a are not opposed to each other. Hereinafter, the thick portion of the insulating film 8a is referred to as a thick portion 80a. Thus, it is possible to improve the withstand voltage between the first extension portion 71a and the second extension portion 72a via the thick portion 80a on the side where the first extension portion 71a and the second extension portion 72a are opposed to each other, and the electrical reliability of the coil device 1 can be improved.

Likewise, the insulating film 8b has a larger thickness on the side where the first extension portion 71b and the second extension portion 72b are opposed to each other than on the side where the first extension portion 71b and the second extension portion 72b are not opposed to each other (the insulating film 8b is provided with a thick portion 80b).

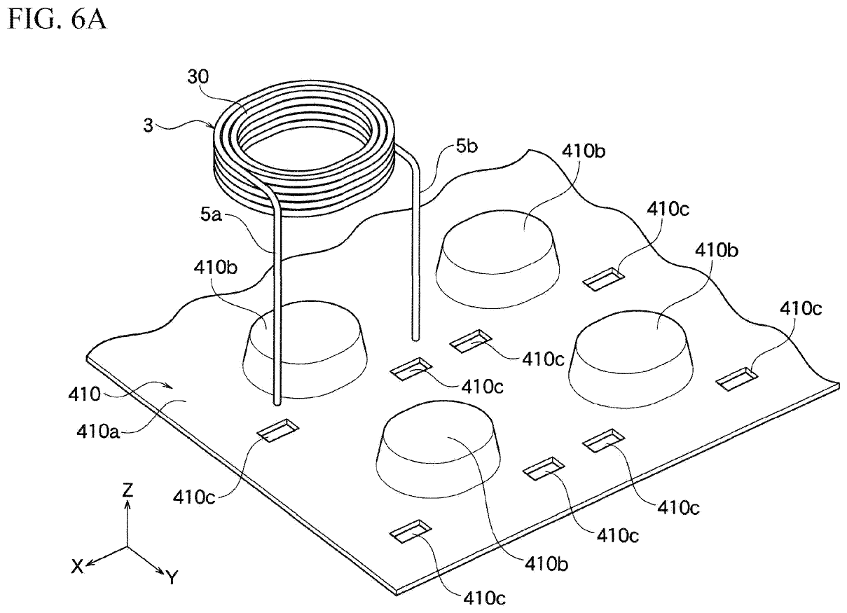

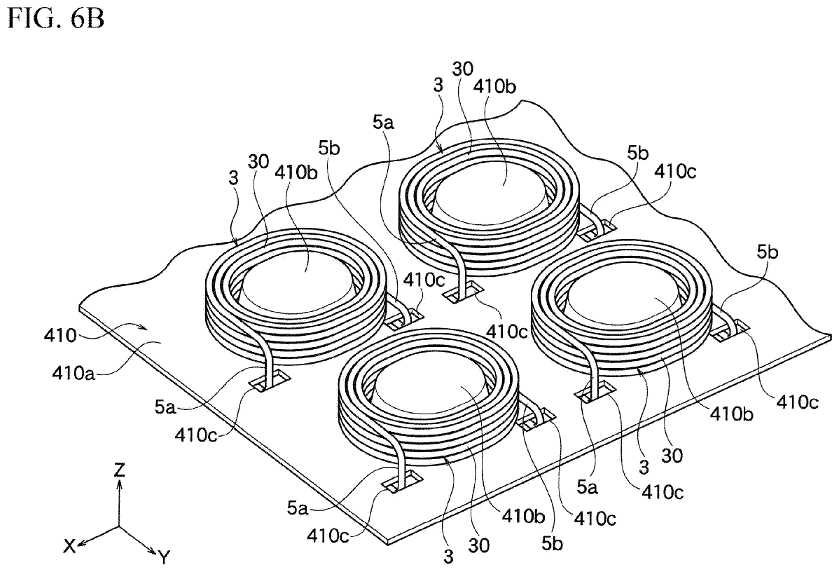

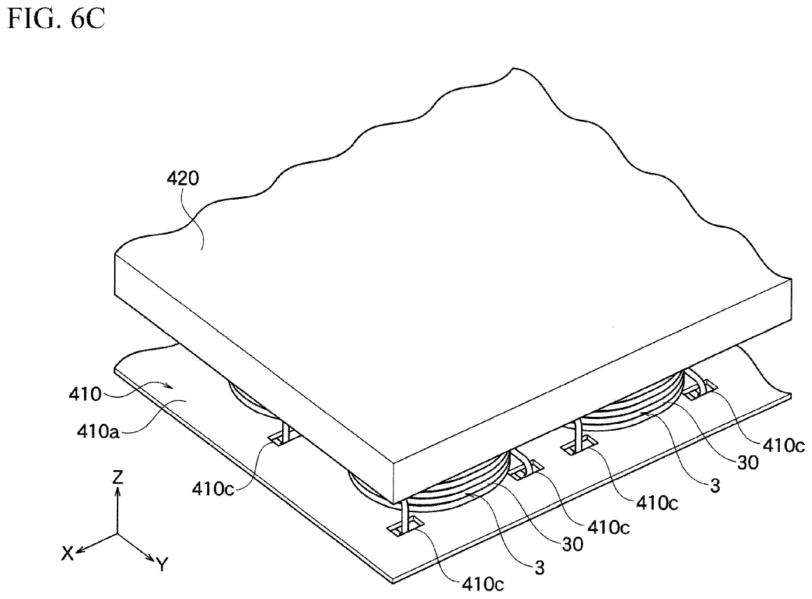

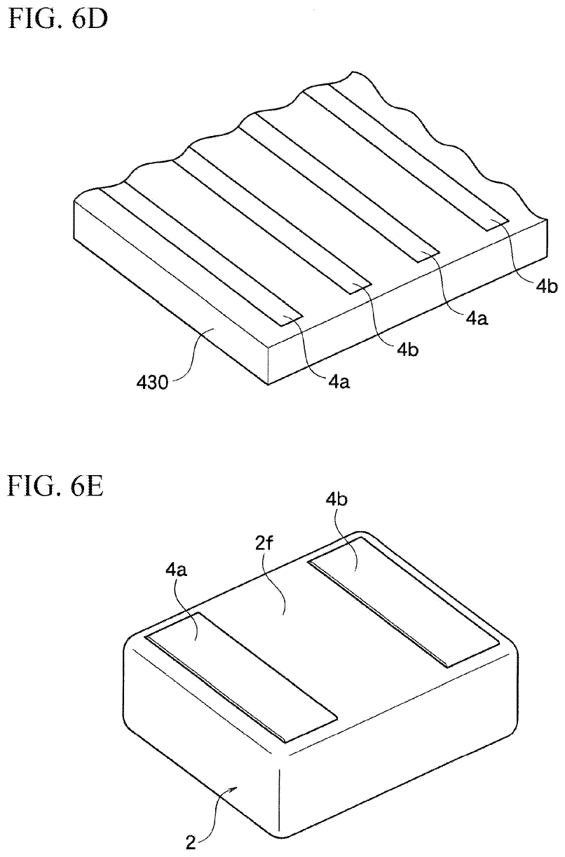

Next, a method of manufacturing the coil device 1 is described. First, as shown in FIG. 6A, a first molded body 410 and a coil 3 wound in an air core are prepared. The first molded body 410 is made of a material that constitutes the core 2 and can be obtained by compaction molding, injection molding, cutting, or the like.

The first molded body 410 includes a support portion 410a, a plurality of winding core portions 410b, and a plurality of notch portions 410c. The support portion 410a has a substantially flat plate shape. The plurality of winding core portions 410b is formed integrally with the support portion 410a and has a substantially cylindrical shape. Hereinafter, one main surface of the support portion 410a on which the winding core portions 410b are formed is referred to as a top surface, and the other main surface of the support portion 410a is referred to as a bottom surface.

Next, as shown in FIG. 6B, the coils 3 are arranged on the winding core portions 410b. The coil 3 may be formed by winding a wire around the outer circumferential surface of the winding core portion 410b. Next, the lead portions 5a and of the coil 3 are pulled out to the bottom surface side of the first molded body 410 via the notch portions 410c.

After the lead portions 5a and 5b are pulled out to the bottom surface side of the first molded body 410, the bent portions 60a and 60b are formed in the lead portions 5a and 5b as shown in FIG. 5. Then, the lead portions 5a and 5b are arranged on the bottom surface of the first molded body 410 in a state where the lead portions 5a and 5b are bent. As a result, the lead portions 5a and 5b are provided with the terminal portions 50a and 50b and the connection portions 53a and 53b shown in FIG. 1, respectively.

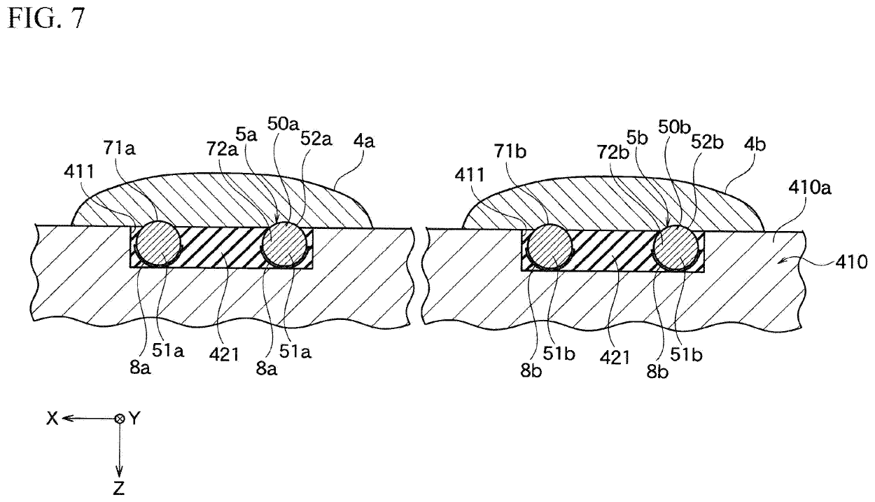

As shown in FIG. 7, a plurality of groove portions 411 may be formed in advance on the bottom surface of the first molded body 410. Then, the terminal portions 50a and 50b pulled out to the bottom surface side of the first molded body 410 may be arranged in the groove portions 411.

The depth of the groove portions 411 may be smaller than the wire diameter of each of the terminal portions 50a and 50b. In this case, when the terminal portion 50a is disposed in the groove portion 411, a part of the terminal portion 50a protrudes outside the groove portion 411. Moreover, when the terminal portion 50b is disposed in the groove portion 411, a part of the terminal portion 50b protrudes outside the groove portion 411.

Next, the first molded body 410 with the plurality of coils 3 shown in FIG. 6B is placed in a mold. Then, as shown in FIG. 6C, the first molded body 410 is combined with a second molded body 420 so that the plurality of coils 3 is covered, and these are compression molded. Thus, as shown in FIG. 6D, a compressed body 430 consisting of the first molded body 410 and the second molded body 420 is formed. The second molded body 420 is made of the material constituting the core 2 and can be obtained by compaction molding, injection molding, or cutting.

During molding the compressed body 430, a part of the molding material constituting the second molded body 420 shown in FIG. 6C flows to the bottom surface side of the first molded body 410 via the notch portions 410c. Thus, as shown in FIG. 7, the groove portions 411 are filled with the molding material constituting the second molded body 420 to form filling portions 421.

As described above, parts of the terminal portions 50a and 50b protrude outside the groove portions 421. Thus, parts of the terminal portions 50a and 50b are exposed (projected) from the compressed body 430 (filling portion 421) as the exposed portions 52a and 52b, respectively. Moreover, the remaining parts of the terminal portions 50a and 50b are embedded in the compressed body 430 (filling portion 421) as the embedded portions 51a and 51b, respectively.

The exposed portion 52a is provided with the first extension portion 71a on one side and the second extension portion 72a on the other side via the bent portion 60a (FIG. 5). Likewise, the exposed portion 52b is provided with the first extension portion 71b on one side and the second extension portion 72b on the other side via the bent portion 60b (FIG. 5).

Next, the bottom surface of the compressed body 430 is irradiated with a laser so as to remove the insulating films of the exposed portions 52a and 52b of the lead portions 5a and 5b exposed from the bottom surface of the compressed body 430. Next, as shown in FIG. 6D, a conductive paste (e.g., Ag paste) is applied to the bottom surface of the compressed body 430 by a method such as screen printing so as to cover the exposed portions 52a and 52b and is cured to form the electrodes 4a and 4b. The electrodes 4a and 4b may be provided with a base electrode layer or a plated layer. The conductive paste can be applied, for example, by screen printing, dispenser, dipping, or the like.

Next, the compressed body 430 is cut so as to individualize the compressed body 430. This forms the core 2 shown in FIG. 6E. If necessary, barrel polishing is performed on the individualized cores 2. Accordingly, the coil device 1 shown in FIG. 1 can be obtained.

As described above, in the coil device 1 of the present embodiment, since the exposed portions 52a and 52b are bent at the positions of the bent portions 60a and 60b as shown in FIG. 5, the lengths of the exposed portions 52a and 52b in their extension direction are extended, and the surface areas of the exposed portions 52a and 52b are increased. As a result, the contact areas between the exposed portions 52a and 52b and the electrodes 4a and 4b are increased. This makes it possible to reduce the contact resistances between the exposed portions 52a and 52b and the electrodes 4a and 4b and to achieve the coil device 1 being excellent in electrical reliability. Moreover, it is possible to increase the bonding strengths between the exposed portions 52a and 52b and the electrodes 4a and 4b and to improve the fixing strengths between the electrodes 4a and 4b and the mounting board.

Moreover, in the present embodiment, the length of the exposed portion 52a in the Y-axis direction can be adjusted according to the length of each of the first extension portion 71a and the second extension portion 72a in the Y-axis direction. Likewise, the length of the exposed portion 52b in the Y-axis direction can be adjusted according to the length of each of the first extension portion 71b and the second extension portion 72b in the Y-axis direction.

Moreover, in the present embodiment, the contact regions between the exposed portions 52a and 52b and the electrodes 4a and 4b are formed along the Y-axis direction. Thus, it is possible to form regions with a high bonding strength between the exposed portions 52a and 52b and the electrodes 4a and 4b (i.e., regions with a high fixing strength between the electrodes 4a and 4b and the mounting board) along the Y-axis direction. Moreover, the exposed portions 52a and 52b are easily accommodated on the inner side of the electrodes 4a and 4b, and the coil device 1 is easily manufactured.

### Second Embodiment

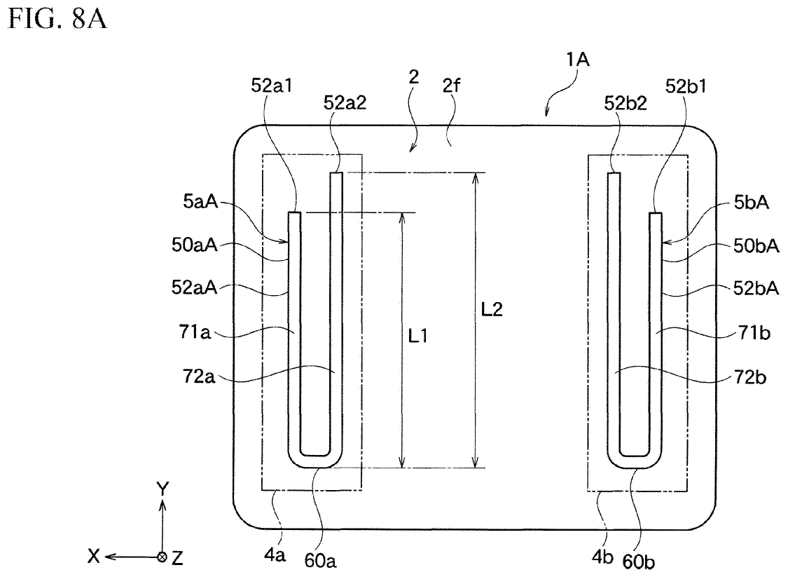

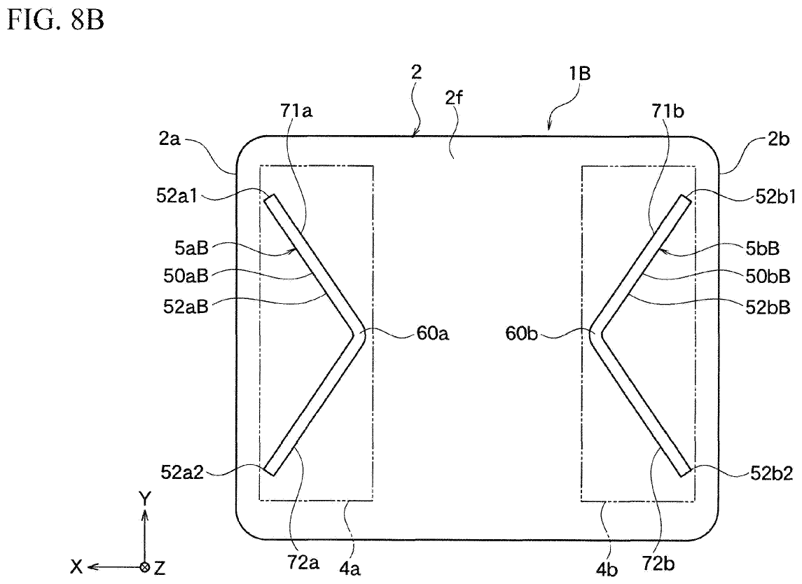

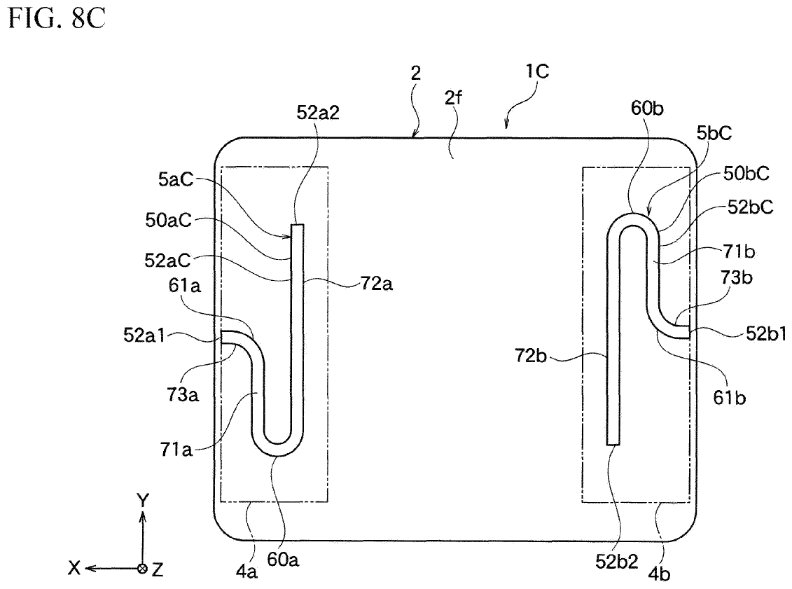

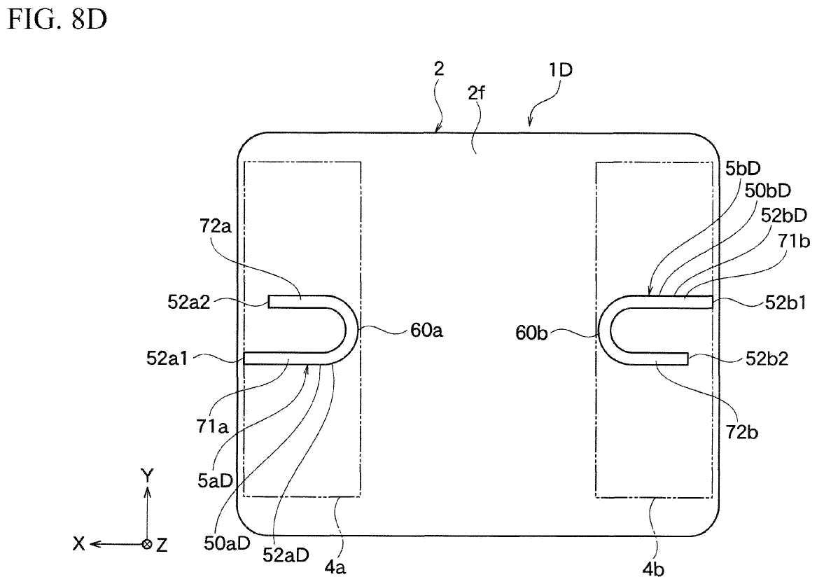

Except for the following matters, a coil device 1A according to Second Embodiment of the present application shown in FIG. 8A has the same structure as the coil device 1 according to First Embodiment. In FIG. 8A, overlapping members with the coil device 1 according to First Embodiment are provided with the same reference numerals and are not described in detail.

The coil device 1A includes lead portions 5aA and 5bA. The lead portions 5aA and 5bA include terminal portions 50aA and 50bA, respectively, and the terminal portions 50aA and 50bA include exposed portions 52aA and 52bA, respectively.

The exposed portion 52aA is different from the exposed portion 52a according to First Embodiment in that the second end 52a2 is disposed on the positive side of the sixth surface 2f of the core 2 in the Y-axis direction relative to the first end 52a1. Moreover, the exposed portion 52bA is different from the exposed portion 52b according to First Embodiment in that the second end 52b2 is disposed on the positive side of the sixth surface 2f of the core 2 in the Y-axis direction relative to the first end 52b1.

Thus, the length L2 of the second extension portion 72a in the Y-axis direction is larger than the length L1 of the first extension portion 71a in the Y-axis direction. 1<L2/L1≤2 may be satisfied, where L2/L1 is a ratio of the length L2 of the second extension portion 72a in the Y-axis direction to the length L1 of the first extension portion 71a in the Y-axis direction.

In the present embodiment, the same effects as First Embodiment can also be obtained. Moreover, in the present embodiment, since the length L2 of the second extension portion 72a in the Y-axis direction is larger than the length L1 of the first extension portion 71a in the Y-axis direction, the fixing strengths between the exposed portions 52aA and 52bA and the electrodes 4a and 4b can be improved, particularly on the center side of the core 2.

### Third Embodiment

Except for the following matters, a coil device 1B according to Third Embodiment of the present application shown in FIG. 8B has the same structure as the coil device 1 according to First Embodiment. In FIG. 8B, overlapping members with the coil device 1 according to First Embodiment are provided with the same reference numerals and are not described in detail.

The coil device 1B includes lead portions 5aB and 5bB. The lead portions 5aB and 5bB include terminal portions 50aB and 50bB, respectively, and the terminal portions 50aB and 50bB include exposed portions 52aB and 52bB, respectively.

The first end 52a1 of the exposed portion 52aB is disposed on the positive side of the sixth surface 2f of the core 2 in the Y-axis direction. The second end 52a2 of the exposed portion 52aB is disposed on the negative side of the sixth surface 2f in the Y-axis direction. That is, the first end 52a1 and the second end 52a2 are arranged opposite to each other with respect to the Y-axis direction. The same applies to the first end 52b1 and the second end 52b2 of the exposed portion 52bB.

The bent portion 60a is disposed between the first end 52a1 and the second end 52a2 in the Y-axis direction. The bent portion 60b is disposed between the first end 52b1 and the second end 52b2 in the Y-axis direction.

The first extension portion 71a and the second extension portion 72a are continuous at a predetermined angle at the position of the bent portion 60a. 0°<θ≤180° may be satisfied, or 90°≤0≤180° may be satisfied, where θ is an angle formed between the first extension portion 71a and the second extension portion 72a. The same applies to the angle formed between the first extension portion 71b and the second extension portion 72b.

In the example shown in FIG. 8B, the first extension portion 71a and the second extension portion 72a are inclined toward the center of the core 2 (away from the first surface 2a of the core 2) as the first extension portion 71a and the second extension portion 72a approach the center of the core 2 in the Y-axis direction. Likewise, the first extension portion 71b and the second extension portion 72b are inclined toward the center of the core 2 (away from the second surface 2b of the core 2) as the first extension portion 71b and the second extension portion 72b approach the center of the core 2 in the Y-axis direction.

However, the first extension portion 71a and the second extension portion 72a may be inclined toward the outer side of the core 2 (toward the first surface 2a of the core 2) as the first extension portion 71a and the second extension portion 72a approach the center of the core 2 in the Y-axis direction. Likewise, the first extension portion 71b and the second extension portion 72b may be inclined toward the outer side of the core 2 (toward the second surface 2b of the core 2) as the first extension portion 71b and the second extension portion 72b approach the center of the core 2 in the Y-axis direction.

The bent portions 60a and 60b are located in a substantially central part of the core 2 in the Y-axis direction, but may be located on one side of the core 2 in the Y-axis direction. Moreover, the inclination angles of the first extension portion 71a and the second extension portion 72a with respect to the Y-axis are approximately the same, but may be different from each other. Moreover, the lengths of the first extension portion 71a and the second extension portion 72a in their extension directions are substantially the same, but may be different from each other. The same applies to the first extension portion 71b and the second extension portion 72b.

In the present embodiment, the same effects as First Embodiment can also be obtained. Moreover, in the present embodiment, each of the first extension portion 71a and the second extension portion 72a has a component extending in the X-axis direction and a component extending in the Y-axis direction. Also, each of the first extension portion 71b and the second extension portion 72b has a component extending in the X-axis direction and a component extending in the Y-axis direction. Thus, it is possible to form regions with a high bonding strength between the exposed portions 52aB and 52bB and the electrodes 4a and 4b along both of the X-axis direction and the Y-axis direction.

Moreover, in the present embodiment, the first extension portion 71a and the second extension portion 72a are continuous at a predetermined angle so as to be arranged in non-parallel. Thus, it is possible to extend the length of the exposed portion 52aB in its extension direction according to the angle formed between the first extension portion 71a and the second extension portion 72a.

### Fourth Embodiment

Except for the following matters, a coil device 1C according to Fourth Embodiment of the present application shown in FIG. 8C has the same structure as the coil device 1 according to First Embodiment. In FIG. 8C, overlapping members with the coil device 1 according to First Embodiment are provided with the same reference numerals and are not described in detail.

The coil device 1C includes lead portions 5aC and 5bC. The lead portions 5aC and 5bC include terminal portions 50aC and 50bC, respectively, and the terminal portions 50aC and 50bC include exposed portions 52aC and 52bC, respectively.

The exposed portion 52aC includes a plurality (two in the present embodiment) of bent portions 60a and 61a. The exposed portion 52bC includes a plurality (two in the present embodiment) of bent portions 60b and 61b. The bent portions 61a and 61b have a substantially L shape and are bent (smoothly curved) by approximately 90° along the sixth surface 2f of the core 2. However, the bent angles of the bent portions 61a and 61b are not limited to this. The bent portions 60a and 60b are located in a substantially central part of the electrodes 4a and 4b in the Y-axis direction, respectively.

The exposed portions 52aC and 52bC are formed point-symmetrically with respect to the center of the core 2, but may be formed linearly symmetrically with respect to the center line of the core 2 parallel to the Y-axis.

In addition to the first extension portion 71a and the second extension portion 72a, the exposed portion 52aC includes a third extension portion 73a. In addition to the first extension portion 71b and the second extension portion 72b, the exposed portion 52aC includes a third extension portion 73b.

The third extension portions 73a and 73b extend along a direction (X-axis direction) substantially orthogonal to the extension direction (Y-axis direction) of the first extension portions 71a and 71b. The third extension portion 73a extends along the sixth surface 2f of the core 2 and is continuous with the first extension portion 71a via the bent portion 61a. The third extension portion 73a has a shape in which the first extension portion 71a extending in the Y-axis direction is bent from the Y-axis direction toward the X-axis direction. Likewise, the third extension portion 73b extends along the sixth surface 2f of the core 2 and is continuous with the first extension portion 71b via the bent portion 61b. The third extension portion 73b has a shape in which the first extension portion 71b extending in the Y-axis direction is bent from the Y-axis direction toward the X-axis direction.

The first end 52a1 of the exposed portion 52aC is located in a substantially central part in the Y-axis direction on the outer edge of the sixth surface 2f of the core 2. The second end 52a2 of the exposed portion 52aC and the bent portion 60a are located opposite to each other in the Y-axis direction. However, the positions of the first end 51a1 and the second end 52a2 are not limited to this and may be changed as appropriate. For example, the first end 52a1 may be located on one side of the sixth surface 2f in the Y-axis direction. Also, the second end 52a2 may be located in a substantially central part of the sixth surface 2f in the Y-axis direction.

The first end 52b1 of the exposed portion 52bC is located in a substantially central part in the Y-axis direction on the outer edge of the sixth surface 2f of the core 2. The second end 52b2 of the exposed portion 52bC and the bent portion 60b are located opposite to each other in the Y-axis direction. However, the positions of the first end 51b1 and the second end 52b2 are not limited to this and may be changed as appropriate. For example, the first end 52b1 may be located on one side of the sixth surface 2f in the Y-axis direction. Also, the second end 52b2 may be located in a substantially central part of the sixth surface 2f in the Y-axis direction.

In the present embodiment, the same effects as First Embodiment can also be obtained. Moreover, in the present embodiment, the exposed portion 52aC includes a plurality of bent portions 60a and 61a, and the exposed portion 52bC includes a plurality of bent portions 60b and 61b. Thus, the lengths of the exposed portions 52aC and 52bC in their extension directions can be extended according to the number of bent portions. Note that, the number of bent portions in the exposed portion 52aC is not limited to two and may be three or more. The same applies to the exposed portion 52bC.

### Fifth Embodiment

Except for the following matters, a coil device 1D according to Fifth Embodiment of the present application shown in FIG. 8D has the same structure as the coil device 1 according to First Embodiment. In FIG. 8D, overlapping members with the coil device 1 according to First Embodiment are provided with the same reference numerals and are not described in detail.

The coil device 1D includes lead portions 5aD and 5bD. The lead portions 5aD and 5bD include terminal portions 50aD and 50bD, respectively, and the terminal portions 50aD and 50bD include exposed portions 52aD and 52bD, respectively.

In the exposed portion 52aD, the first extension portion 71a and the second extension portion 72a extend along the X-axis direction on the sixth surface 2f of the core 2. The length of the second extension portion 72a in its extension direction (X-axis direction) is smaller than the length of the first extension portion 71a in its extension direction (X-axis direction). The same applies to the first extension portion 71b and the second extension portion 72b.

The exposed portions 52aD and 52bD are formed point-symmetrically with respect to the center of the core 2. However, the exposed portions 52aD and 52bD may be formed linearly symmetrically with respect to the center line of the core 2 parallel to the Y-axis. Instead, the exposed portions 52aD and 52bD may be arranged on a diagonal line of the core 2.

The bent portions 60a and 60b are located in a substantially central part of the core 2 in the Y-axis direction and arranged so as to face each other in the X-axis direction. The bent portions 60a and 60b may be arranged on one side of the sixth surface 2f of the core 2 in the Y-axis direction.

In the present embodiment, the same effects as First Embodiment can also be obtained. Moreover, in the present embodiment, contact regions between the exposed portions 52aD and 52bD and the electrodes 4a and 4b are formed along the X-axis direction. Thus, it is possible to form regions having a high bonding strength between the exposed portions 52aD and 52bD and the electrodes 4a and 4b along the X-axis direction.

### Sixth Embodiment

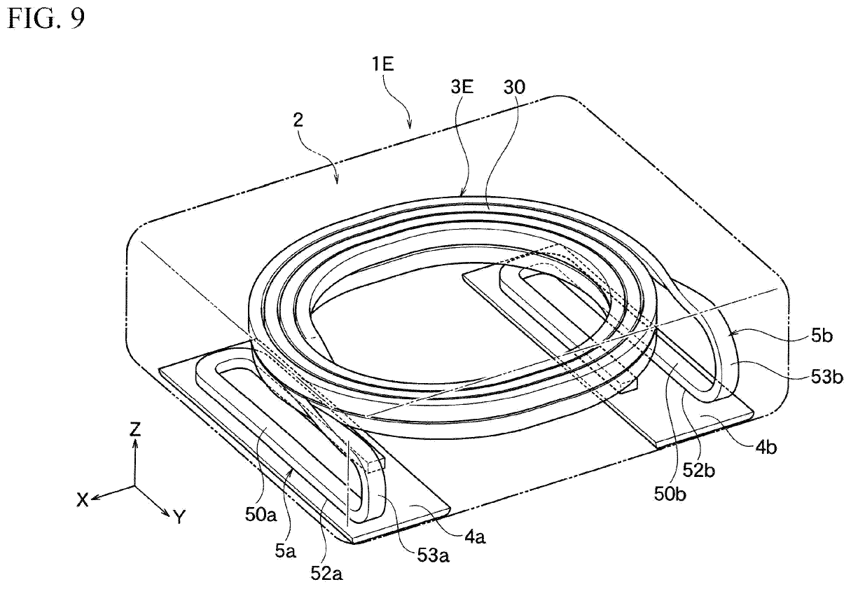

Except for the following matters, a coil device 1E according to Sixth Embodiment of the present application shown in FIG. 9 has the same structure as the coil device 1 according to First Embodiment. In FIG. 9, overlapping members with the coil device 1 according to First Embodiment are provided with the same reference numerals and are not described in detail.

The coil device 1E includes a coil 3E. The coil 3E is different from the coil 3 according to First Embodiment in that the coil 3E is made of a flat wire. The coil 3E is wound flatwise, but may be wound edgewise.

In the present embodiment, the same effects as First Embodiment can also be obtained. Moreover, in the present embodiment, since the coil 3E is made of a flat wire, it is easy to secure the contact areas between the exposed portions 52a and 52b and the terminal electrodes 4a and 4b.

The present application is not limited to the above-mentioned embodiments and may variously be modified within the scope of the gist of the present application.

In each of the above-mentioned embodiments, an application example of the present application to an inductor is described, but the present application may be applied to other coil devices.

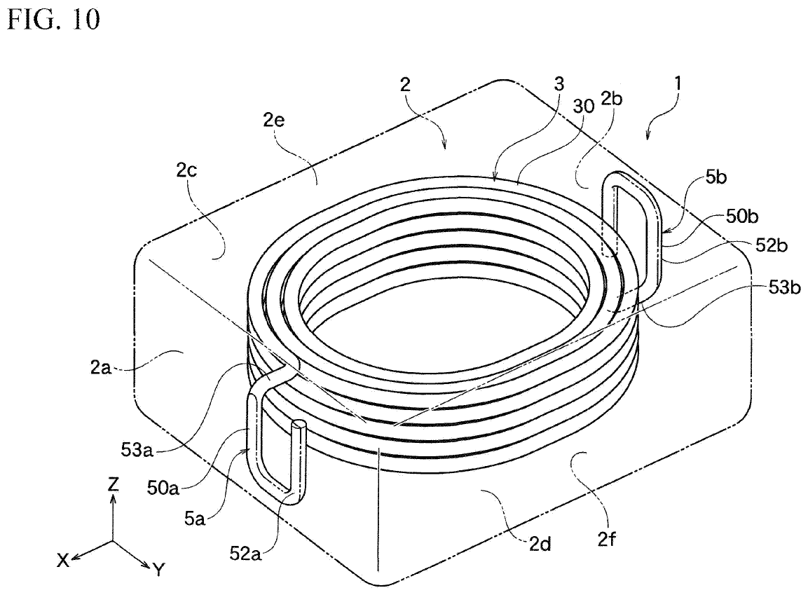

In each of the above-mentioned embodiments, the exposed portions 52a and 52b (FIG. 5) are exposed from the sixth surface 2f of the core 2 shown in FIG. 1, but may be exposed from the first surface 2a and the second surface 2b of the core 2 (side of the core 2), respectively, as shown in FIG. 10. In this case, the exposed portion 52a may extend in a U shape in the Z-axis direction as a whole on the first surface 2a. Also, the exposed portion 52b may extend in a U shape in the Z-axis direction as a whole on the second surface 2b. Instead, the exposed portions 52a and 52b may be exposed from another surface of the core 2.

In each of the above-mentioned embodiments, as shown in FIG. 1, the electrodes 4a and 4b are formed only on the sixth surface 2f of the core 2, but may be formed across other surfaces.

In each of the above-mentioned embodiments, as shown in FIG. 5, the bent portions 60a and 60b are formed in the terminal portions 50a and 50b, respectively, but a bent portion may be formed in only one of the terminal portions 50a and 50b.

In each of the above-mentioned embodiments, as shown in FIG. 4, the thickness of the electrode 4a is maximum between the first extension portion 71a and the second extension portion 72a, but the thickness of the electrode 4a may be substantially constant. Instead, the thickness of the electrode 4a may be smaller than the thickness of the exposed portion 52a between the first extension portion 71a and the second extension portion 72a. The same applies to the electrode 4b.

In each of the above-mentioned embodiments, the terminal portions 50a and are provided with the embedded portions 51a and 51b and the exposed portions 52a and 52b, but may be provided with only the exposed portions 52a and 52b.

In each of the above-mentioned embodiments, as shown in FIG. 6C, the core 2 is formed of the first molded body 410 and the second molded body 420, but may be formed of one molded body. For example, the core 2 may be formed by placing the coil 3 inside a mold, filling the inside of the mold with a molding material, and compressing and molding it.

In First to Third Embodiments, Fifth Embodiment, and Sixth Embodiment, the number of bent portions 60a may be plural, or the number of bent portions 60b may be plural.

The techniques shown in Second to Fifth embodiments may be applied to Sixth Embodiment.

### DESCRIPTION OF THE REFERENCE NUMERICAL

1, 1A-1E . . . coil device
2 . . . core
3 . . . coil
30 . . . winding portion
4a, 4b . . . electrode
5b . . . lead portion
50b . . . terminal portion
51a, 51b . . . embedded portion
52a, 52b . . . exposed portion
52a1, 52b1 . . . first end
52a2, 52b2 . . . second end
53a, 53b . . . connection portion
60b, 61a, 61b . . . bent portion
71a, 71b . . . first extension portion
72a, 72b . . . second extension portion
73a, 73b . . . third extension portion
8a, 8b . . . insulating film
80b . . . thick portion
410 . . . first molded body
410a . . . support portion
410b . . . winding portion
410c . . . notch portion
420 . . . second molded body
430 . . . compressed body

What is claimed is:

1. A coil device comprising:
a core;
a coil including a winding portion disposed inside the core and a lead portion leading from the winding portion; and
an electrode formed on an electrode formation surface of the core,
wherein
the lead portion includes a terminal portion extending to the electrode formation surface,
the terminal portion includes:
an embedded portion embedded inside the core; and
an exposed portion exposed from the electrode formation surface and connected to the electrode, and
the exposed portion includes a bent portion.

2. The coil device according to claim 1, wherein the exposed portion includes a first extension portion and a second extension portion extending along the electrode formation surface and continuing via the bent portion.

3. The coil device according to claim 2, wherein the first extension portion and the second extension portion are arranged substantially in parallel.

4. The coil device according to claim 2, wherein the first extension portion and the second extension portion are continuous at a predetermined angle.

5. The coil device according to claim 2, wherein
the electrode includes a first electrode and a second electrode,
the first electrode and the second electrode are arranged separately along a first direction, and
the first extension portion and the second extension portion extend along a second direction.

6. The coil device according to claim 5, wherein
a first end and a second end of the exposed portion in its extension direction are arranged on one side in the second direction, and
the bent portion is disposed on the other side in the second direction.

7. The coil device according to claim 6, wherein the first end of the exposed portion in its extension direction is disposed on one side of the electrode formation surface in the second direction relative to the second end of the exposed portion in its extension direction.

8. The coil device according to claim 2, wherein
the electrode includes a first electrode and a second electrode,
the first electrode and the second electrode are arranged at a predetermined interval along the electrode formation surface in a first direction, and
the first extension portion and the second extension portion extend along the electrode formation surface in the first direction.

9. The coil device according to claim 2, wherein
the lead portion includes a connection portion connecting the winding portion and the terminal portion,
the first extension portion is connected to the connection portion, and
the second extension portion is disposed closer to a center of the core than the first extension portion.

10. The coil device according to claim 1, wherein the bent portion has a substantially U shape.

11. The coil device according to claim 1, wherein the bent portion comprises a plurality of bent portions.

12. The coil device according to claim 1, wherein
the lead portion includes a first lead portion and a second lead portion,
the terminal portion includes:
a first terminal portion provided on the first lead portion; and
a second terminal portion provided on the second lead portion,
the exposed portion includes:
a first exposed portion provided on the first terminal portion; and
a second exposed portion provided on the second terminal portion, and
the first exposed portion and the second exposed portion have substantially the same shape.

13. The coil device according to claim 1, wherein the electrode is made of a conductive paste.

14. The coil device according to claim 3, wherein the electrode has a maximum thickness in a region between the first extension portion and the second extension portion.

15. The coil device according to claim 1, wherein
the coil comprises a wire covered with an insulating film, and
a surface of the embedded portion is covered with the insulating film.

16. The coil device according to claim 1, wherein
the coil comprises a wire covered with an insulating film, and
an end of the exposed portion in its width direction orthogonal to its extension direction is covered with the insulating film.

17. The coil device according to claim 3, wherein
the coil comprises a wire covered with an insulating film,
an end of the exposed portion in its width direction orthogonal to its extension direction is covered with the insulating film, and
the insulating film has a larger thickness on the side where the first extension portion and the second extension portion are opposed to each other than on the side where the first extension portion and the second extension portion are not opposed to each other.
